(19) United States
(12) Patent Application Publication
(10) Pub. No.: US 2008/0014901 A1
(43) Pub. Date: Jan. 17, 2008

(54) Method and apparatus for incorporating emergency 911 service into personal computer based nomadic telephony operations

(75) Inventors: Cecil F. Motley, Rolling Hills, CA (US); Yu Fei, Cerritos, CA (US)

Correspondence Address: BLAKELY SOKOLOFF TAYLOR & ZAFMAN, 1279 OAKMEAD PARKWAY, SUNNYVALE, CA, 94085-4040, US

(73) Assignee: Intra Tel LLC

(21) Appl. No.: 11/582,097

(22) Filed: Oct. 16, 2006

Related U.S. Application Data
(60) Provisional application No. 60/830,862, filed on Jul. 14, 2006.

(51) Int. Cl. H04M 11/04

(52) U.S. Cl. 455/404.1

(57) ABSTRACT

A device includes a virtual telephony interface and a nomadic emergency process operates with the virtual telephony interface. The nomadic emergency process operates to update current location information of the apparatus and to verify the location. A system includes a portable device having a personal computer (PC) to telephony unit. The portable device operates to communicate current location information to an E911 system.

This application claims the benefit of U.S. Provisional Application No. 60/830,862 filed Jul. 14, 2006.

### BACKGROUND

1. Field

This invention relates to acquiring a proper Public Safety Answering Point (PSAP, i.e. emergency 911 center) when an emergency call is made from a nomadic personal computing device.

2. Description of the Related Art

Current technology includes the ability to make an emergency 911 call from a conventional telephony device connected to the public switched telephone network (PSTN) via hard-lines, wireless, or IP network provided the call origination device has a fixed registered and verifiable address. When an emergency 911 call is made, the associated PSAP queries the database that contains information that maps the caller ID to the registered address. This information includes name, street location and call back number. There are slight variations of this process depending on the capability of the PSAP involved in the 911 call.

The element that is common to all current procedures is the requirement for the user to be at a fixed location tied to their caller ID data in the Automatic Location Identifier (ALI) database. A method for handling nomadic continuously changing addresses has previously not existed. If your location data changes using the current system, telephony service must be discontinued until a new registered address is entered into the PSAP ALI. This process can take three to five days, however it insures that the Federal Communications Commission (FCC) regulations are not violated.

Currently, the FCC requires that 911 calls be routed to the nearest PSAP for the deployment of emergency services to the emergency Caller's current geographical location. The location of the caller and a call back number must also be provided to the PSAP. The ability for the PSAP operator to call back the emergency Caller in the event of an accidental disconnect, is also required.

### BRIEF DESCRIPTION OF THE DRAWINGS

The embodiments are illustrated by way of example, and not by way of limitation, in the figures of the accompanying drawings and in which like reference numerals refer to similar elements and in which:

FIG. 1 illustrates a block diagram of an embodiment of the invention having all the elements of a nomadic 911 system;

FIG. 2 illustrates a User Logon Window Graphical User Interface for one embodiment of the nomadic 911 system's portable device Client Software;

FIG. 3 illustrates a Map Locator Window Graphical User Interface for one embodiment of the nomadic 911 system's portable device Client Software;

FIG. 4 illustrates a Virtual Telephone Graphical User Interface for one embodiment of the Nomadic 911 system's portable device Client Software;

FIG. 5 illustrates the Client Side Components associated with one embodiment of the nomadic 911 system;

FIG. 6 illustrates a Flow diagram for an embodiment; and

FIG. 7 illustrates an embodiment included on a device in a system.

### DETAILED DESCRIPTION OF THE INVENTION

The invention generally relates to acquiring a proper Public Safety Answering Point (PSAP i.e. emergency 911 center) when an emergency call is made from a nomadic portable computing device (e.g., a PC, PDA, etc.) whose geographical location continuously changes (i.e. nomadic). Referring to the figures, exemplary embodiments of the invention will now be described. The exemplary embodiments are provided to illustrate the invention and should not be construed as limiting the scope of the invention.

In one embodiment, the process used to make a 911 call from a nomadic device interfaces seamlessly with the existing PSAP's equipment and operational configuration. In this embodiment, during the emergency call process, the portable device has a virtual implementation of a conventional telephony device (i.e. telephone) capable of PC-to-Phone and Phone-to-PC operations. One embodiment integrates nomadic 911 Service with the telephony operations associated with the IP-to-PSTN gateway telecommunication apparatus described in U.S. Pat. No. 6,721,282 (“Telecommunication data compression apparatus and method”), which is incorporated by reference in its entirety.

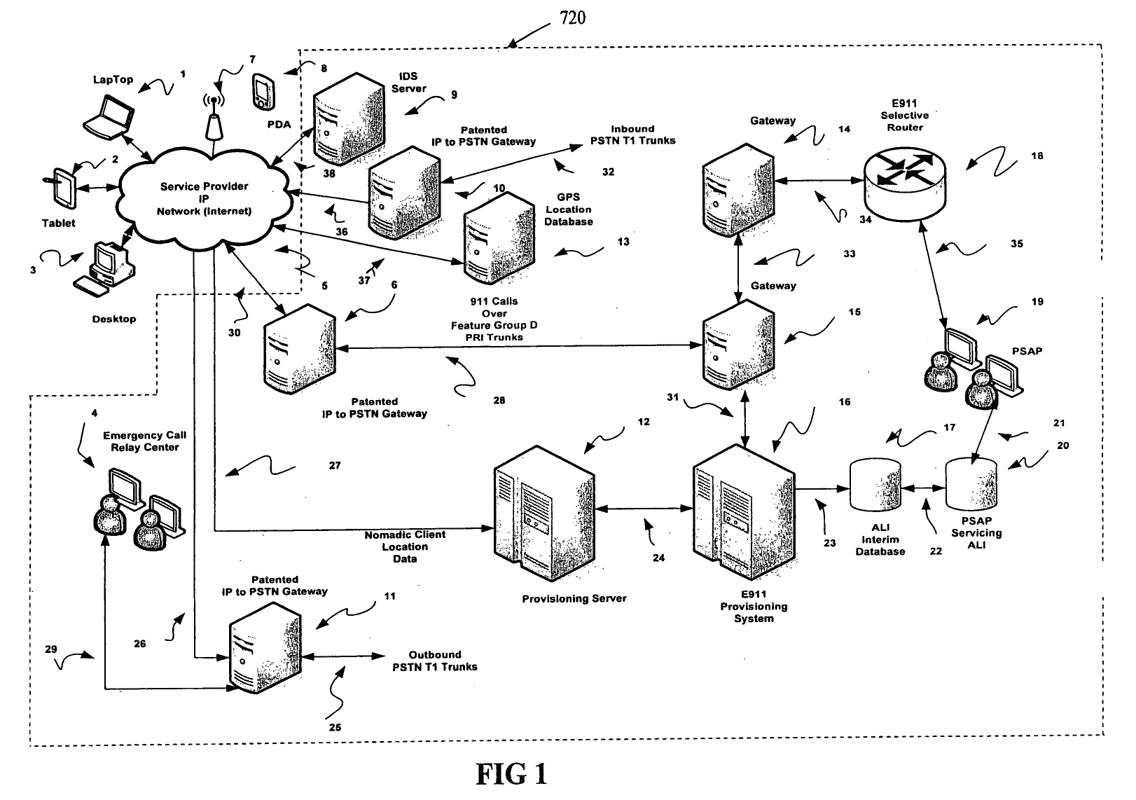

FIG. 1 illustrates an embodiment of an Emergency 911 system for nomadic portable devices, such as portable computers, PDAs, digital cameras, personal gaming device, etc. In one embodiment a software component is resident on the user's portable device 1, 2, 3, 8 and provides a virtual telephone interface for outgoing and incoming calls to the PSTN from a portable device connected to the public Internet or an equivalent private network 5. In another embodiment, hardware is disposed on a portable device to provide a virtual telephone interface for outgoing and incoming calls to the PSTN from a portable device connected to the public Internet or an equivalent private network 5. The IP-to-PSTN Gateway bridges the portable device's IP network interface and associated specialized packet structure to an ITU standard PSTN switch interface (i.e. T1, T3, etc.). The database 20, which is updated each time the PC user changes location, holds the most recently verified location information for the user. In one embodiment the IDS server 9, provides administration and IP routing control for the entire nomadic E911 process. The PSAP hardware routing network 14, 15, 18 provides call routing to the proper PSAP based on the most current data in the Caller ALI database 20. The dashed line in FIG. 1 makes up the E911 system 720.

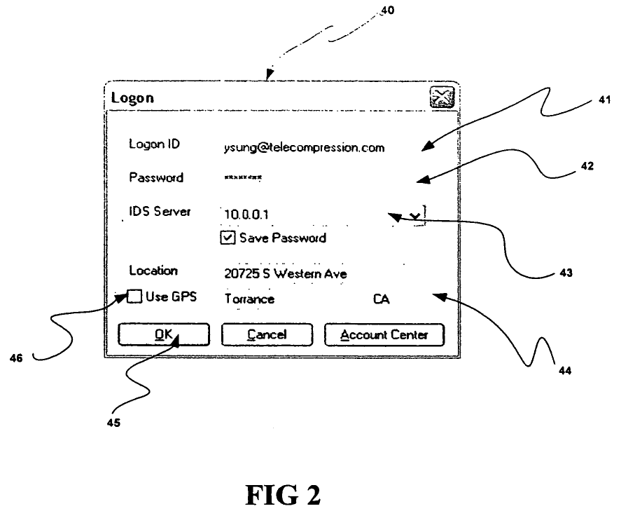

In one embodiment, associated specialized application software or circuitry must be installed on a user's portable computing device 1, 2, 3, 8. In one embodiment the application software must be launched or the specialized circuitry must operate prior to executing outgoing or incoming calls and involves a user logon interface illustrated in FIG. 2.

As illustrated in FIG. 2, the logon window 40 displays during an embodiment launch process and request ID 41, Password 42, IDS Server 43 and Location Data 44. In one embodiment, the location information must be entered and verified, otherwise the logon procedure will default the user to the Emergency Caller Relay Center (ECRC) 4 in the event a 911 call is made. In one embodiment a check box 46 is included that enables an embodiment to get location data from an associated GPS receiver instead of the manually entered address. In this embodiment location data retrieval is an automatic process. The logon process continues by clicking/touching the OK button 45.

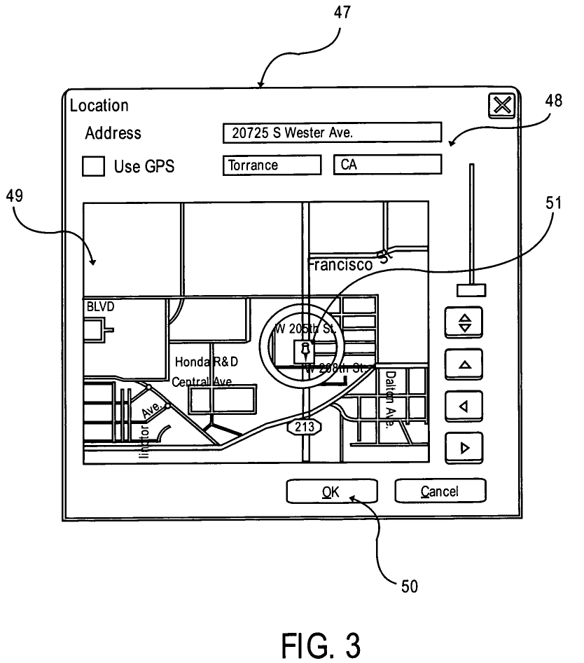

After the initial logon process is completed, one embodiment automatically queries an address verification database 12. As illustrated in FIG. 3 a map is displayed on a GUI 47 based on the location information from the manual input location data or the GPS coordinates data, thus providing the user with feedback regarding their current location 48, 49, 51. If the location data is not a verifiable street address, one embodiment automatically sets up routing instructions to call the ECRC 4 if a 911 emergency call is made by the user. The ECRC is a centralized center that will manually route the emergency call to the PSAP nearest the user based on verbal information. If during the logon process the address is verifiable, the location data 27 will be sent to an address location provisioning server 12, 16, which in turn sends the data to the PSAP servicing center ALI 17, 20. This location data is filed in association with a user's specialized 10 digit phone number, which is retrieved based on the user's caller ID (10 digit phone number) during an emergency 911 call session.

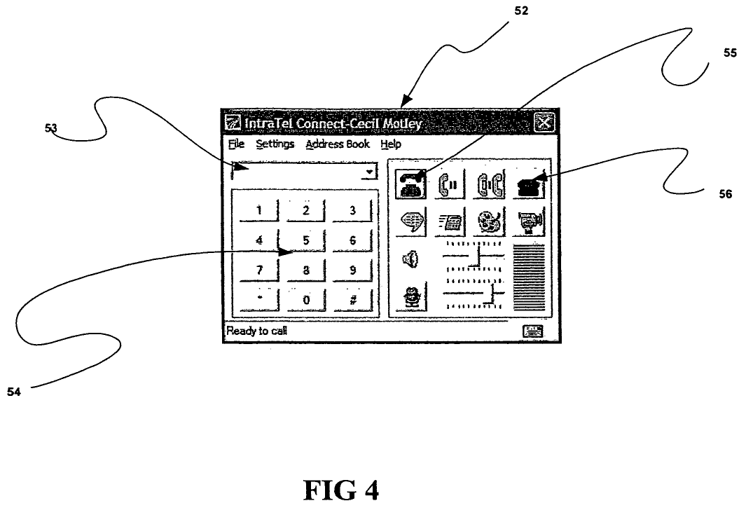

If the user agrees with the location data displayed on the map, they Click/touch the OK button 50 and the virtual telephone User Interface 52 is displayed as illustrated in FIG. 4. The user is now able to use PC-to-Phone and Phone-to-PC service world wide by entering the telephone number with the keypad 54, PC keyboard, or speaking a number or name associated with a number into a microphone and Clicking/touching the phone button 55 (or saying a command into a microphone). When a user wants to hang up, the user presses/touches telephone 56 or says a verbal command.

To place an emergency 911 call from the portable device, the user enters 911 in the GUI text box or says a command or the numbers “9” “1” “1” into a microphone for the outgoing call or presses/touches a special key, such as the F11 button on a portable device 1, 2, 3, 8. The user's device sends a call request packet to the IP-to-PSTN Gateway 6, which in turn calls the E911 Selective Routing System 14, 15, 18 that routes the call to the proper PSAP based on the Caller ID information previously placed in the provisioning server system 12 13.

When the PSAP answers the call 19, the Caller ID (10 digit ANI) is used to retrieve the emergency Callers current location data and callback number from the associated ALI 20 database. Voice traffic between the emergency Caller and the PSAP takes place between voice paths 30, 28, 33, 34, 35. If the call is dropped due to problems at the Callers location, the PSAP operator uses the callback number to re-engage the emergency Caller. The callback voice traffic then becomes an inbound call 32 that is answered by the IP-to-PSTN Gateway 10, which in turn routes the voice traffic from the PSAP to the emergency Caller's PC or PDA device 1, 2, 3 8.

In one embodiment, if during the login process, the user did not provide a verifiable address, an emergency 911 call will be routed directly to the ECRC 4 for handling the emergency situation. Location data will be handled verbally direct to an emergency operator. When 9-1-1 is keyed in on the user's GUI 52, the application software places the call directly through the Telecommunications IP-to-PSTN Gateway 11.

In one embodiment, the process of updating the ALI 17, 20 currently takes approximately 15 minutes from the time a user inputs their current location either manually or using GPS. In the event an emergency call is needed during the period in which the ALI 20 is being updated, the software automatically places the 911 call to the ECRC 4 location data will be handled verbally direct to an emergency operator.

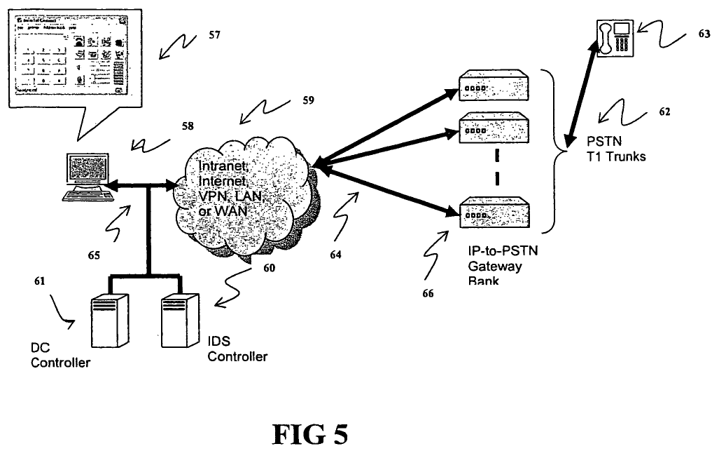

FIG. 5 illustrates components associated with the Client side in one embodiment. In one embodiment the User Application Software provides a remote interface to the IP-to-PSTN Gateways and the Provisioning Server.

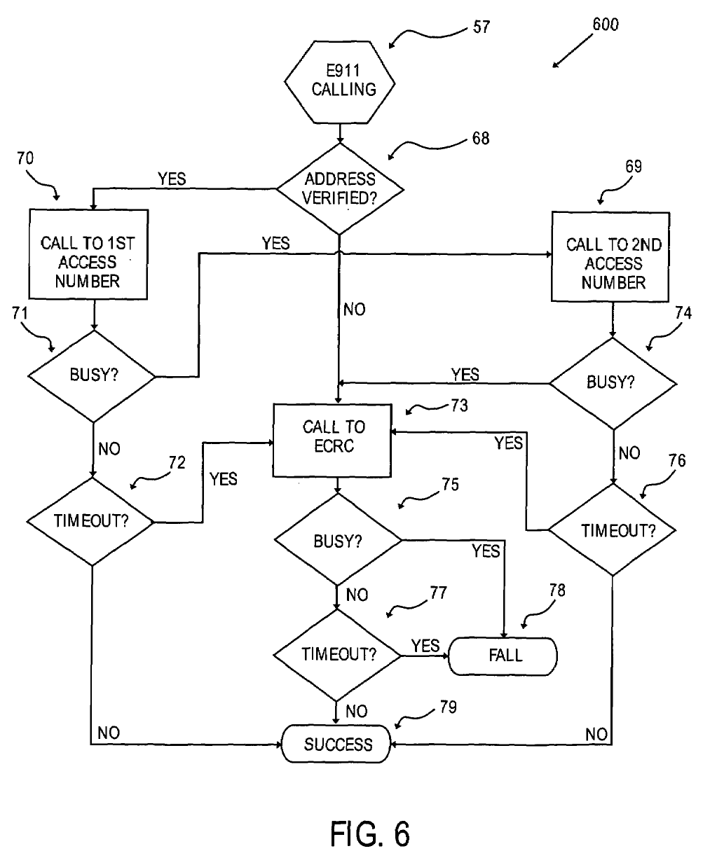

In one embodiment, when a nomadic user places an emergency 911 call, the Client software application performs the process shown in the flow diagram in FIG. 6. If the Client application software is launched on the nomadic user's portable device and, the F11 button is clicked/touched, 911 is entered in the GUI text box 53 or a verbal command is spoken initiates the emergency calling process. Clicking/touching the call button 55 or saying a command causes the Client application to retrieve the AS Servers IP address, port number and the number of available channels on the AS server. The Client application uses this information to place an emergency call to a pre-designated PSAP routing network. If a verified address has been associated with the user at block 68, the network is contacted by placing a telephone call using an IP-to-PSTN gateway to a pre-designated Emergency Service Provider (ESP) access number in block 70.

The ESP network in turn routes the call to the closet PSAP based on the caller ID information retrieved during the logon process and passed in the ANI during the emergency call process. If the dialed number connects (i.e., it is determined in block 71 the dialed number is not busy), the ESP attempts to match the caller ID number with location data previously placed in the ALI database. If there is no connection (i.e., block 71 determines the number is busy or block 72 determines that a timeout occurred (e.g., 10 seconds)), a timeout triggers re-dialing the ESP using an alternate telephone number 69. If there is still no connection (i.e., block 74 determines the number is busy or block 76 determines that a timeout occurred (e.g., 10 seconds)), the software places a call to the ECRC in block 73 and the process is completed using verbal exchange of location data.

If the call is successfully completed using the ESP number and an ALI match is obtained, the ESP routes the call to the nearest local PSAP and the process is complete. If the ECRC calling process fails, the E911 call will not be completed (i.e., block 75 determines the number is busy or block 77 determines that a timeout occurred (e.g., 10 seconds), block 78 determines a failure occurred.

For the mobile user whose portable device has an associated GPS receiver, a background procedure continuously updates the user location information, and tracks the verifiability of the address. In the event of an E911 call, the Client software determines whether the ESP access numbers should be used or a direct call to the ECRC.

The IDS is the depository for location provisioning keys and the ESP phone numbers that are used in routing the emergency calls to the proper PSTN. The IDS server also contains the User account database (i.e. User IDs and Passwords) and IP addresses of the E911 IP-to-PSTN gateway servers.

During the logon process, the Client software application automatically uses the IDS server as a proxy between the Client and the ALI provisioning network. For security and account management purposes, a coded (e.g., encrypted) key is used to secure the transfer of location data from the Client application to the ALI provisioning server. In this embodiment only authenticated accounts can transfer location data to the ALI provisioning server.

The IP-to-PSTN gateway is the link between the processes that take place on the nomadic Users portable device and the PSTN. This gateway uses the techniques described in detail in U.S. Pat. No. 6,721,282, which is incorporated by reference in its entirety.

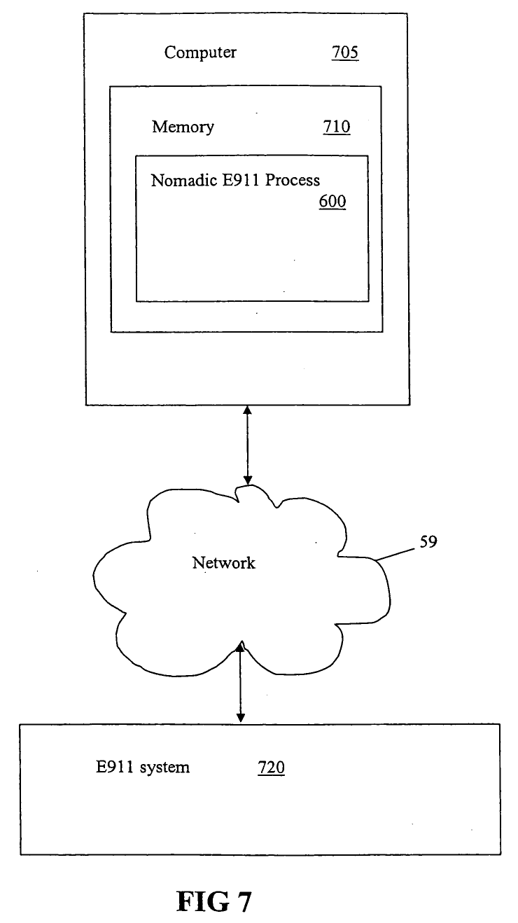

FIG. 7 is a diagram of one embodiment of a system utilizing the nomadic E911 embodiments described above. The system may include a portable device 700 that communicates with an E911 system 720 (see FIG. 1). Devices that use the nomadic E911 process 600 (see FIG. 6) may include, computers, PDAs, handheld devices, cellular phones, gaming consoles, wireless devices and other similar devices. Any combination of these devices may communicate using the system.

Each device may include or execute a nomadic E911 process 600. The nomadic E911 process 600 may be a software application, firmware, an embedded program, hardware or similarly implemented program. The program may be stored in a non-volatile memory or storage device or may be hardwired. For example, a nomadic E911 process 600 may be stored in system memory 710 during use and on a hard drive or similar non-volatile storage.

System memory may be local random access memory (RAM), static RAM (SRAM), dynamic RAM (DRAM), fast page mode DRAM (FPM DRAM), Extended Data Out DRAM (EDO DRAM), Burst EDO DRAM (BEDO DRAM), erasable programmable ROM (EPROM) also known as Flash memory, RDRAM® (Rambus® dynamic random access memory), SDRAM (synchronous dynamic random access memory), DDR (double data rate) SDRAM, DDRn (i.e., n=2, 3, 4, etc.), etc., and may also include a secondary memory (not shown).

The secondary memory may include, for example, a hard disk drive and/or a removable storage drive, representing a floppy disk drive, a magnetic tape drive, an optical disk drive, etc. The removable storage drive reads from and/or writes to a removable storage unit. The removable storage unit represents a floppy disk, magnetic tape, optical disk, etc., which is read by and written to by the removable storage drive. As will be appreciated, the removable storage unit may include a machine readable storage medium having stored therein computer software and/or data.

The nomadic E911 process 600 may utilize any encryption protocol including SSL (secure sockets layer), IPsec, Station-to-Station and similar protocols. In one example embodiment, the encryption program may include a Diffie-Hellman key-exchange protocol, an RSA or modified RSA encryption/decryption algorithm. In one embodiment, computer 705 runs an operating system, such as Windows®, LINUX, or a Mac OS (operating system) operating system.

The nomadic E911 process 600 may be used for communication with devices over a network 59. The network 59 may be a local area network (LAN), wide area network (WAN) or similar network. The network 59 may utilize any communication medium or protocol. In one example embodiment, the network 59 may be the Internet. In another embodiment, the devices may communicate over a direct link including wireless direct communications.

Device 700 may also include a communications interface (not shown). The communications interface allows software and data to be transferred between computer 707 and external devices. Examples of communications interfaces may include a modem, a network interface (such as an Ethernet card), a communications port, a PCMCIA (personal computer memory card international association) slot and card, a wireless LAN interface, etc. Software and data transferred via the communications interface are in the form of signals which may be electronic, electromagnetic, optical or other signals capable of being received by the communications interface. These signals are provided to the communications interface via a communications path (i.e., channel). The channel carries the signals and may be implemented using wire or cable, fiber optics, a phone line, a cellular phone link, a wireless link, and other communications channels.

In alternative embodiments, the secondary memory may include other ways to allow computer programs or other instructions to be loaded into device 700, for example, a removable storage unit and an interface. Examples may include a program cartridge and cartridge interface (such as that found in video game devices), a removable memory chip or card (such as an EPROM (erasable programmable read-only memory), PROM (programmable read-only memory), or flash memory) and associated socket, and other removable storage units and interfaces which allow software and data to be transferred from the removable storage unit to device 1601.

In this document, the term “computer program product” may refer to the removable storage units, and signals. These computer program products allow software to be provided to device 700. Embodiments of the invention may be directed to such computer program products. Computer programs (also called computer control logic) are stored in memory 710, and/or the secondary memory and/or in computer program products. Computer programs may also be received via the communications interface. Such computer programs, when executed, enable device 700 to perform features of embodiments of the present invention as discussed herein. In particular, the computer programs, when executed, enable computer 705 to perform the features of embodiments of the present invention. Such features may represent parts or the entire process of FIG. 6. Alternatively, such computer programs may represent controllers of computer 705.

In an embodiment where the invention is implemented using software, the software may be stored in a computer program product and loaded into device 705 using the removable storage drive, a hard drive or a communications interface. The control logic (software), when executed by computer 705, causes computer 705 to perform functions described herein.

Computer 705 may include a display (not shown) for displaying various graphical user interfaces (GUIs) and user displays. The display can be an analog electronic display, a digital electronic display a vacuum fluorescent (VF) display, a light emitting diode (LED) display, a plasma display (PDP), a liquid crystal display (LCD), a high performance addressing (HPA) display, a thin-film transistor (TFT) display, an organic LED (OLED) display, a heads-up display (HUD), etc.

In another embodiment, the invention is implemented primarily in hardware using, for example, hardware components such as application specific integrated circuits (ASICs) using hardware state machine(s) to perform the functions described herein. In yet another embodiment, the invention is implemented using a combination of both hardware and software.

In the description above, numerous specific details are set forth. However, it is understood that embodiments of the invention may be practiced without these specific details. For example, well-known equivalent components and elements may be substituted in place of those described herein, and similarly, well-known equivalent techniques may be substituted in place of the particular techniques disclosed. In other instances, well-known circuits, structures and techniques have not been shown in detail to avoid obscuring the understanding of this description.

Embodiments of the present disclosure described herein may be implemented in circuitry, which includes hardwired circuitry, digital circuitry, analog circuitry, programmable circuitry, and so forth. These embodiments may also be implemented in computer programs. Such computer programs may be coded in a high level procedural or object oriented programming language. The program(s), however, can be implemented in assembly or machine language if desired. The language may be compiled or interpreted. Additionally, these techniques may be used in a wide variety of networking environments. Such computer programs may be stored on a storage media or device (e.g., hard disk drive, floppy disk drive, read only memory (ROM), CD-ROM device, flash memory device, digital versatile disk (DVD), or other storage device) readable by a general or special purpose programmable processing system, for configuring and operating the processing system when the storage media or device is read by the processing system to perform the procedures described herein. Embodiments of the disclosure may also be considered to be implemented as a machine-readable or machine recordable storage medium, configured for use with a processing system, where the storage medium so configured causes the processing system to operate in a specific and predefined manner to perform the functions described herein.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. An apparatus comprising:
a virtual telephony interface; and
a nomadic emergency process coupled with the virtual telephony interface, wherein the nomadic emergency process operates to update current location information of the apparatus and to verify the location.

2. The apparatus of claim 1, wherein the apparatus operates to perform nomadic E911 operations with personal computer (PC)-to-Phone and Phone- to-PC operations.

3. The apparatus of claim 1, wherein the virtual telephony interface integrates with an Internet Protocol (IP)-to-public switched telephone network (PSTN) gateway.

4. The apparatus of claim 1, further comprising a display, wherein the display operates to display a map indicating the location of the apparatus.

5. The apparatus of claim 1, wherein location information is entered through a location interface.

6. The apparatus of claim 1, further comprising a global positioning system (GPS) device, the GPS device operates to provide location information.

7. The apparatus of claim 1, wherein verified location information is transmitted to an address location provisioning server, and address information associated with a specific caller identification (ID) is updated in a Public Safety Answering Point (PSAP) servicing center Automatic Location Identifier (ALI) database.

8. The apparatus of claim 7, wherein an emergency telephone call is made through an IP-PSTN gateway to a pre-determined Emergency Service Provider (ESP), and the ESP routes the emergency telephone call to a closest PSAP.

9. The apparatus of claim 1, wherein an emergency call is manually routed to an Emergency Caller Relay Center (ECRC) based on verbal location information when location information is unverified.

10. The apparatus of claim 1, wherein the apparatus is a portable device.

11. A method comprising:
storing location information in a memory of a portable device;
performing personal computer (PC) to telephony operations;
connecting to an emergency system through an Internet Protocol (IP)-to-public switched telephone network (PSTN);
requesting verification of location information;
automatically routing an emergency call to a closest Public Safety Answering Point (PSAP) if the location information is verified.

12. The method of claim 11, further comprising
displaying a map indicating the location of the portable device.

13. The method of claim 11, wherein the location information is manually entered through a user interface.

14. The method of claim 11, wherein the location information is automatically stored in the memory by a global positioning system (GPS) device.

15. The method of claim 11, further comprising:
transmitting verified location information to an address location provisioning server, and
updating address information associated with a specific caller identification (ID) in a Public Safety Answering Point (PSAP) servicing center Automatic Location Identifier (ALI) database.

16. The method of claim 15, wherein an emergency telephone call is made through an IP-PSTN gateway to a pre-determined Emergency Service Provider (ESP), and the ESP routes the emergency telephone call to the closest PSAP.

17. The method of claim 11, wherein, an emergency call is manually routed to the closest PSAP based on verbal location information when location information is unverified.

18. A machine-accessible medium containing instructions that, when executed, cause a machine to:
perform personal computer (PC) to telephony operations on a portable device;
store location information in a memory of the portable device;
connect to an emergency system through an Internet Protocol (IP)-to-public switched telephone network (PSTN);
request verification of location information;
automatically route an emergency call to a closest Public Safety Answering Point (PSAP) if the location information is verified.

19. The machine-accessible medium of claim 18, further containing instructions that, when executed, cause a machine to:
make the emergency call to an Emergency Call Relay Center based on verbal location information if the location information is unverified.

20. The machine-accessible medium of claim 18, further containing instructions that, when executed, cause a machine to:
display a map indicating the location of the portable device.

21. The machine-accessible medium of claim 18, wherein the location information is manually entered through a user interface.

22. The machine-accessible medium of claim 18, wherein the location information is determined by a global positioning system (GPS) device.

23. The machine-accessible medium of claim 18, further containing instructions that, when executed, cause a machine to:
transmit verified location information to an address location provisioning server, and
update address information associated with a specific caller identification (ID) in a Public Safety Answering Point (PSAP) servicing center Automatic Location Identifier (ALI) database.

24. The machine-accessible medium of claim 23, wherein an emergency telephone call is made through the IP-PSTN gateway to a pre-determined Emergency Service Provider (ESP), and the ESP routes the emergency telephone call to the closest PSAP.

25. A system comprising:
a portable device including personal computer (PC) to telephony unit, wherein the portable device operates to communicate current location information to an E911 system.

26. The system of claim 25, the portable device further including a display, wherein the display operates to display a map indicating the location of the portable device.

27. The system of claim 25, the portable device further including a user interface, wherein location information is entered through the user interface.

28. The system of claim 25, the portable device further is coupled to a global positioning system (GPS) device, wherein the GPS device operates to provide current location information.

29. The system of claim 25, the E911 system includes an address location provisioning server and a Public Safety Answering Point (PSAP) servicing center Automatic Location Identifier (ALI) database, wherein verified location information is transmitted to the address location provisioning server, and address information associated with a specific caller identification (ID) is updated in the PSAP ALI database.

30. The system of claim 29, the E911 system includes an Internet Protocol (IP)-to-public switched telephone network (PSTN) gateway, wherein an emergency telephone call is made through the IP-PSTN gateway to a pre-determined Emergency Service Provider (ESP), and the ESP routes the emergency telephone call to a closest PSAP.

31. The system of claim 25, wherein an emergency call is manually routed to an Emergency Caller Relay Center (ECRC) based on verbal location information when location information is unverified.
